(19) United States
(12) Patent Application Publication
(10) Pub. No.: US 2005/0080768 A1
(43) Pub. Date: Apr. 14, 2005

(54) Methods and apparatus for dynamic service discovery from Web services representation chain

(75) Inventors: Liang-Jie Zhang, Cortlandt Manor, NY (US); Qun Zhou, Cortlandt Manor, NY (US); Tian-Jy Chao, Bedford, NY (US); John Youssef Sayah, Sleepy Hollow, NY (US); Jen-Yao Chung, Yorktown Heights, NY (US); Hung-Yang Chang, Scarsdale, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 10/683,783

(22) Filed: Oct. 10, 2003

(51) Int. Cl. G06F 7/00

(52) U.S. Cl. 707/3

(57) ABSTRACT

Techniques are provided for discovering services available in accordance with an information network. For example, the invention provides methods and apparatus for dynamic service discovery from at least one chain of one or more service description documents employing one or more of automatic change detection of the chain, result aggregation and caching capability. The invention enables businesses to easily retrieve up-to-date web services linked and nested multi-level deep in the service description documents.

### FIELD OF THE INVENTION

The present invention generally relates to services available over an information network and, more particularly, to techniques for providing dynamic service discovery from web service representation chains.

### BACKGROUND OF THE INVENTION

As an enabling technology, World Wide Web (or web, for short) services have been adopted to represent services accessible over the Internet and to communicate with other such services in a standard way. The emergence of web services expedites the next evolution of dynamic and on-demand electronic business (e-business). Web services are reusable web components with standard interfaces described in Web Services Description Language (WSDL) and can be accessed by universal clients such as wireless devices, web clients and other application clients over the Internet.

Web services can be published to a Universal Description, Discovery and Integration (UDDI) registry, public or private, or service description documents such as Extensible Markup Language (XML) based WS-Inspection (or WSIL, for short) documents.

The design of a UDDI registry enables publishing as well as a search of trading partners' businesses and their web services to specified categories. A UDDI registry is a central place to store such information and locations about web services. There are two types of UDDI registries, i.e., private and public registries. For an application developer, he or she can publish the web services to public UDDI registries operated, for example, by International Business Machines (IBM) Corporation, Microsoft, Hewlett Packard, or SAP. However, if the web services are private or confidential in nature, the best way is to publish them to private UDDI registries.

On the other hand, for testing purposes or small-scale integration, publishing web services to service description documents such as WS-Inspection documents would be the easiest way since WSIL enables web services discovery, deployment and invocation without the need for a UDDI registry.

It is known that a WS-Inspection document provides a mechanism for aggregating references to pre-existing service description documents which have been authored in any number of formats. These inspection documents are then made available at the point-of-offering for the service as well as through references which may be placed within a content medium such as HyperText Markup Language (HTML). For example, a uniform resource locator (URL) convention to locate WSILs may be as follows: http://www.myorg-wsd.com/inspection.wsil. Furthermore, the UDDI registries and the WSILs are tightly associated by a WS-Inspection data tag “wsiluddi.” In a WSIL, a reference pointer is used to connect to a business or service published in a UDDI registry.

WSIL or future equivalent service specification mechanisms are attractive to an extending business user community, as they do not require the rigor and complexity of setting up and maintaining a fully operational business registry such as a UDDI. Hence, more users are experimenting using WSIL as a convenient registry for their web services. What is simply required is the access from the users web sites to published web services and gathering the web service links into one service description document at a default location, for example, http://www.xmethods.net/inspection.wsil.

Therefore, exploring appropriate business applications published as web services in the service description documents is a critical issue. As mentioned above, service description documents are collections of pointers to other documents that list web services available on a web site. Service description documents can point to other service description documents, a UDDI business or service entry, and WSDL documents. Once you have found the service you want at a site, you can import the WSDL document to generate a web services invocation client proxy for consuming those web services.

One typical WSIL based web services discovery application scenario is a design collaboration. Service description documents provide an easy and convenient way to allow design partners and supply chain companies to publish their services on the Web. However, design collaboration requires an effective and efficient service discovery mechanism for design team building and design service outsourcing to work together to create innovative, profitable products that meet narrow market windows.

Thus, a search or discovery mechanism for such applications should be effective in terms of time and uniform in terms of interfaces.

Currently, there are manual, iterative search processes. An example of such a process is as follows:
(1) specify the location of the WSIL;
(2) execute the search for the specified service description document;
(3) display a list of links contained in the service description document; and
(4) manually select a link to display the details of the page for the contents, comprising web services, other WSIL links, etc.

To obtain all the web services referenced by the links, i.e., to find by service name or business name, one needs to repeat step (3), step (4), and gather services by name manually.

Some of the major shortcomings of the manual search process can be summarized as follows:
(1) no automated or programmable process for batch search of multiple linked service description documents;
(2) no efficient way for deep exploration of linked service description documents (i.e., the manual link execution of real-time search is time-consuming);
(3) no capability to aggregate services found when traversing linked service description documents; and
(4) no uniform discovery mechanism for aggregating search results from multiple data sources, e.g., UDDI registries and service description documents such as WSIL documents.

Therefore, a need exists for improved service description document discovery techniques.

### SUMMARY OF THE INVENTION

The present invention provides techniques for automatically discovering services available in accordance with an information network. For example, in a first aspect of the invention, such a technique comprises the following steps/operations. A request is obtained from a client to perform a search for one or more services. A set (e.g., chain) of one or more service description documents is searched, based on the client request. The searching step/operation further comprises detecting that one or more changes have occurred in the set of one or more service description documents. Then, a result of the search is made available to the client.

The detecting step/operation may further comprise comparing at least a portion of a current instance of the set of one or more service description documents to at least a portion of a previous instance of the set of one or more service description documents. The portion of the previous instance of the set of one or more service description documents may be stored in a cache. The portion of the current instance of the set of one or more service description documents may be used to update a cache.

The services discovery technique may further comprise the step/operation of aggregating sub-results obtained during the searching step/operation into an aggregated result, and then making the aggregated result available to the client. The sub-results may comprise services obtained during the searching step/operation.

Still further, the services discovery technique may comprise the step/operation of obtaining information used to control performance of the searching step/operation. Also, the searching step/operation may be performed in association with multiple data sources. The searching step/operation may also be configurable to be performed at different levels of granularity. The one or more services being discovered may comprise one or more web services.

In a second aspect of the invention, a technique for querying one or more service description documents comprises the following steps/operations. At least one query (e.g., client request) is received. A target data source is identified for the query. Then, the target data source with at least one service description document is explored. The query may comprise at least one location of a service description document. The query can be expressed in terms of one or more of: (i) an extensible markup language; (ii) a HyperText Transport Protocol request string; (iii) one or more input parameters in an application programming interface; and (iv) a form comprising at least one of a location of a service description document and a search criterion. The target data source may comprise at least one of: (i) at least one service description document with zero or more traverse links to other service description documents; and (ii) a service container.

In a third aspect of the invention, a system for automatic exploration of one or more multi-level service description document chains comprises the following components: (i) a service container containing at least one cached web service; (ii) a chain change detection module to detect changes in service description document chains; and (iii) a service description document exploration engine coupled to the service container and the chain change detection module for performing automatic exploration of multi-level service description document chains. The system may further comprise one or more control parameters to control operation of the service description document exploration engine.

The service container may comprise at least one of: (i) cached information about one or more web services referenced in at least one service description document chain; (ii) service description document chain information including at least the location of at least one service description document; and (iii) utilities to update and maintain the cached content. The cached information for each web service found in the service description document chain further may comprise at least one of: (i) a service description document name/URL; (ii) a service name; (iii) an abstract; (iv) a WSDL location; and (iv) one or more category descriptions. The cached information for each service description document chain may comprise at least one of: (i) a creation time; (ii) a document size; (iii) a URL or service description document location; and (iv) other signatures of a service description document.

Further, the chain change detection module may perform one of a time-initiated checking operation and an on-demand checking operation. The one or more control parameters may comprise one or more parameters for controlling: (i) a maximum depth to traverse; (ii) turning caching on or off; (iii) target data source display data; (iv) a stopping condition for performing chain change detection; and (v) a determination of which data source is to be a target data source. The system may also serve as a web services search agent.

In a fourth aspect of the invention, a technique for creating a service description document chain comprises the following steps/operations. A set of published service description documents is collected by using a manual search and/or an automated search engine application programming interface. Related service description documents are linked to form a service description document chain. A chain change detection process is invoked to collect changes to the service description documents in the chain. Then, a service description document exploration process is invoked to explore the chain. Results of the processes are stored in a cache.

In a fifth aspect of the invention, a technique for providing a service, in accordance with a service provider, to allow discovery of services available in accordance with an information network, comprises the step of deploying a service discovery system operative to: (i) obtain a request from a client to perform a search for one or more services; (ii) search a set of one or more service description documents, based on the client request, wherein the searching step further comprises detecting that one or more changes have occurred in the set of one or more service description documents; and (iii) make a result of the search available to the client.

Thus, advantageously, the invention may provide methods and apparatus for dynamic service discovery from web service representation chains (i.e., service description document chains) with one or more of automatic change detection of the chain, result aggregation and caching capability. The invention solves the above-mentioned business problems and enables businesses to easily retrieve up-to-date web services linked and nested multi-level deep in the service description documents.

For example, in an illustrative embodiment of the invention, a service discovery technique includes steps to automatically search linked and nested service description documents for web services, aggregate the services found in each document, and return them to the requester program. Thus, the invention automates the discovery process and provides real-time feedback. This is important because the web service descriptions in those documents can change frequently as new web services get published and old ones get removed. The ability to dynamically re-explore the linked and nested service description documents for an updated list of web services is extremely valuable to businesses requiring access to web services. The invention therefore provides a solution to automate and manage the repetitive elements of the task while rendering the service exploration aspect efficient through pre-fetched link calculation and reference caching and aggregation.

In another illustrative embodiment of the invention, a method is provided for aggregating the services found in each document, grouping them per document, and returning all web services found to the requester. In addition, the invention may also aggregate search results from multiple data sources, e.g., UDDI registries and service description documents such as WSIL documents.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a service discovery system and an environment in which the system may be implemented, according to an embodiment of the present invention;

FIG. 2 is a diagram illustrating a methodology for use in accordance with a service description document exploration engine, according to an embodiment of the present invention;

FIG. 3 is a diagram illustrating a methodology for use in a service description document exploration engine for performing exploration of service description document chains and updating of service containers, according to an embodiment of the present invention;

FIG. 4 is a diagram illustrating a service container architecture, according to an embodiment of the present invention;

FIG. 5 is a diagram illustrating details of a chain change detection process, according to an embodiment of the present invention;

FIG. 6 is a diagram illustrating an example of a service description document chain, according to an embodiment of the present invention;

FIG. 7 is a diagram illustrating an example of a service description document chain for design collaboration, according to an embodiment of the present invention;

FIG. 8 is a diagram illustrating a WSIL exploration tool interface, according to an embodiment of the present invention;

FIG. 9 is a diagram illustrating an available service list interface, according to an embodiment of the present invention;

FIG. 10 is a diagram illustrating a search criteria specification interface, according to an embodiment of the present invention;

FIG. 11 is a diagram illustrating an aggregated search result interface, according to an embodiment of the present invention;

FIG. 12 is a diagram illustrating details of a service description document chain creation process, according to an embodiment of the present invention;

FIG. 13 is a diagram illustrating an agent-based web services discovery system, according to an embodiment of the invention;

FIG. 14 is a diagram illustrating another aggregated search result interface, according to an embodiment of the present invention; and

FIG. 15 is a diagram illustrating an illustrative hardware implementation of a computing system in accordance with which one or more components/methodologies of the present invention may be implemented, according to an embodiment of the present invention.

### DETAILED DESCRIPTION OF PREFERRED EMBODIMENTS

The following description will illustrate the invention using an exemplary WSIL environment to specify and describe a service and related access specification process, including references or aggregation of references thereof. It should be understood, however, that the invention is not limited to use with any particular environment. Rather, the invention is more generally applicable to any environment in which it is desirable to provide efficient and effective service discovery techniques.

It is to be appreciated that a “service description document chain,” as illustratively referred to herein, pertains to WSIL documents that are hosted on the Web and linked together via a web link or uniform resource identifier (URI). Thus, these linked documents can be traversed and contents be retrieved by following the web links, which can be nested multi-level deep.

The remainder of the detailed description is organized as follows. First, there is a description of main components of a service discovery system, followed by a description of mechanisms used to enhance the WSIL search capability. Next, there is a description of an exemplary service description document chain exploration methodology usable by a service discovery system.

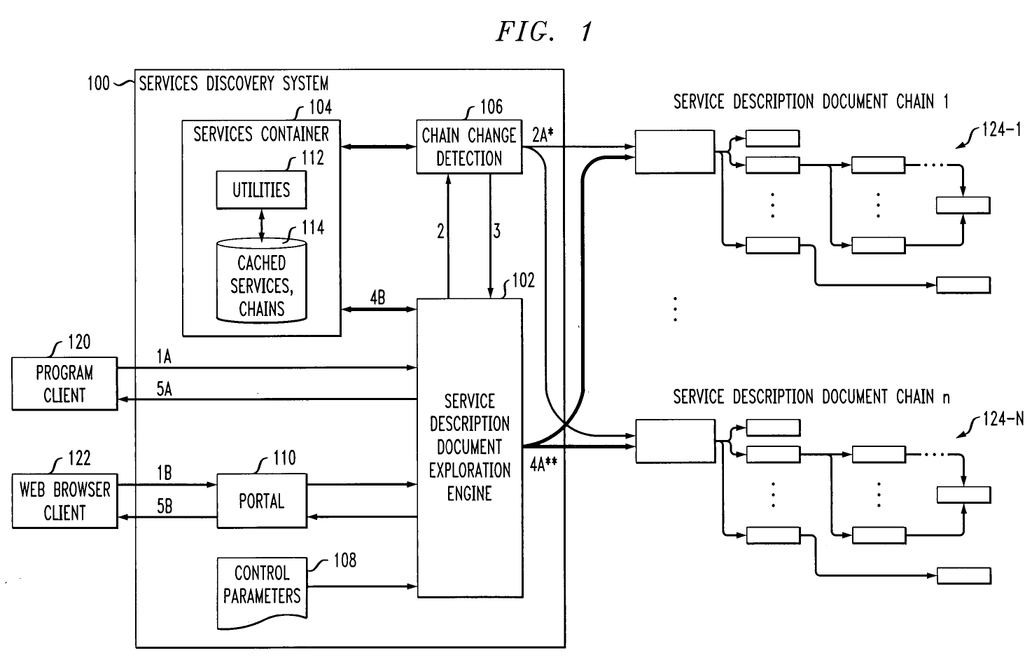

Referring initially to FIG. 1, a diagram illustrates a service discovery system and an environment in which the system may be implemented, according to an embodiment of the present invention. As shown, service discovery system 100 comprises a service description document exploration engine 102, a services container 104, a chain change detection module 106, control parameters 108 and a portal 110. Services container 104 includes utilities 112 and cache 114 for storing services and chains. System 100 interacts with one or more program clients 120 and one or more Web browser clients 122. System 100 searches service description document chains 1 through N (124-1 through 124-N).

The following will explain the functionality of the main components of system 100 that process service description documents containing web services descriptions. Again, WSIL is used as an example of such a service description document.

Service description document exploration engine 102 is the component that provides the mechanism for automatic, deep exploration of service description documents linked together. Details of engine operation will be provided below in the context of FIG. 3.

Services container 104 stores service cached information of each service description document chain and web services in the chain to be used by chain change detection module 106. At a minimum, the service name and the sources (e.g., the WSIL signature) will be captured for each service in the appropriate service container. Further details on the services container will be given below.

Chain change detection module 106 implements a unique caching methodology that categorizes the service description document chains for related web services, grouped/linked via a root service description document. More specifically, module 106 automatically detects changes in the service description documents, using attributes such as creation time, size, and other signatures of a service description document, by checking the service description document chains on a time-initiated basis against the contents cached in services container 104. Further details on the chain change detection module will be given below.

Control parameters 108 include initial setup data for service description document exploration engine 102. By way of example, control parameter data 108 includes: (i) data specifying maximum depth or level to traverse with configurable granularity, i.e., service description document exploration engine 102 explores in a depth-first fashion for a given link before the peer links are explored; (ii) data specifying whether caching mechanism is turned on or off; (iii) data specifying chain change detection with configurable granularity; (iv) target data source information including default data to be cached in the service container and/or the known service description document chains; and (v) information related to a display data level, i.e., short or long description.

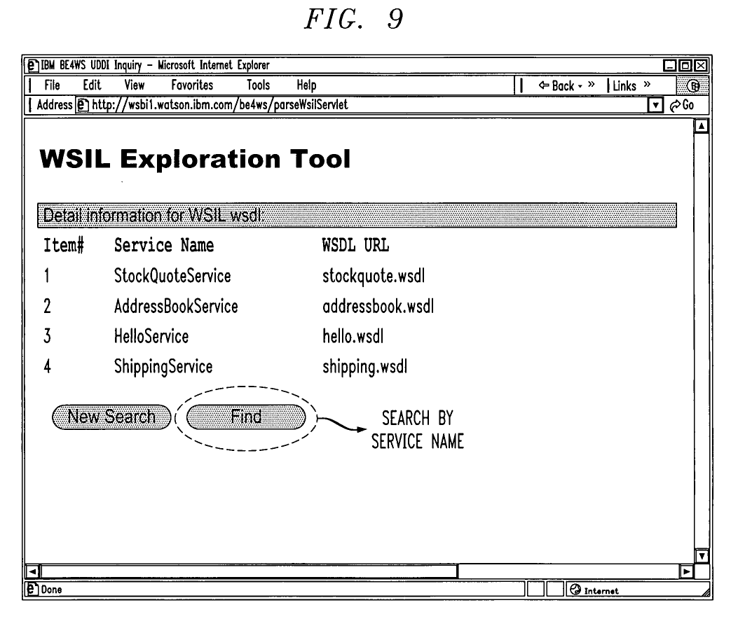

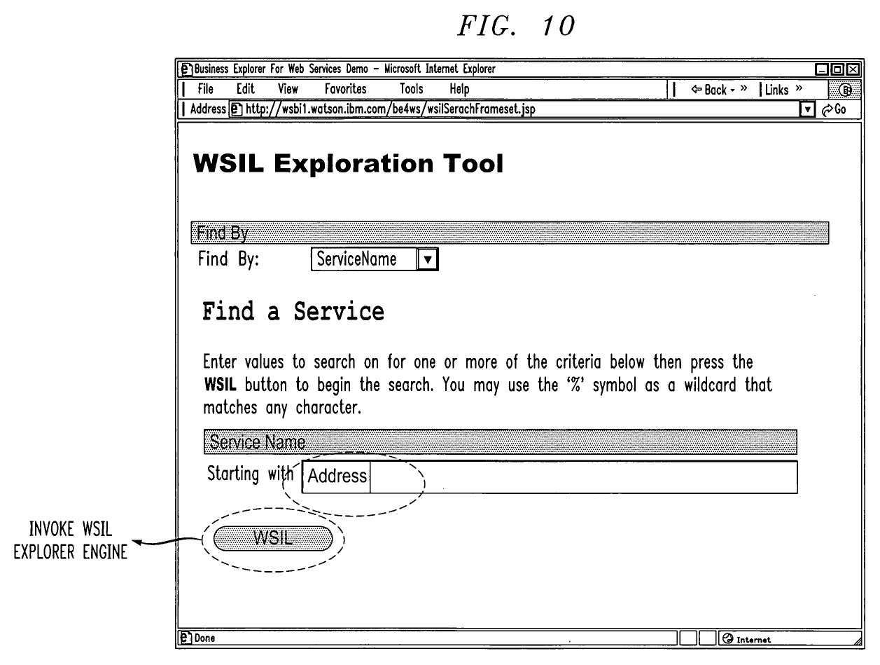

The invention provides techniques/mechanisms to enhance WSIL search capability, by way of example:
(i) A categorization and service description document chain creation process that categorizes service description documents into human-friendly categories, and creates service description document chains for each category, i.e., travel, finance, car, food, clothing, etc.
(ii) A service description document chain exploration method that searches by service name or key words, enabled by the categorization, of a service description document chain that the service description document exploration engine explores.
(iii) Caching technology for efficient web services discovery in a service description document chain. The caching technology is implemented as chain change detection module 106, which detects changes in the service description document chain, collects the set of changed service description document links, which is returned to service description document exploration engine. The engine only needs to re-explore the modified service description documents and not the entire chains, and refreshes the contents of the service container accordingly. That is, if any service description documents are added, changed, or removed, the corresponding service information in the service container will be updated by the service description document exploration engine.
(iv) A configurable exploration mechanism for caching, searching and change detection at various granularity. The architecture can support inspection at different depths of WSIL links to traverse for each chain by specifying the maximum depth or level to traverse. The granularity is configurable. Meanwhile, the caching mechanism is also configurable to be turned on or off.
(v) Result aggregation of multiple service description document chains. A web services result set can be obtained by traversing one service description document chain. The service description document chain exploration engine described herein can further aggregate multiple result sets obtained by traversing multiple service description document chains and return all of them as one result. See a sample of such request in Listing 8 below.
(vi) Result aggregation of multiple data sources. The service description document chain exploration engine described herein can further aggregate multiple data sources, i.e., UDDI registries and service description documents, and present the one aggregated final result. See a sample request in Listing 9, and the aggregated result in FIG. 9, which shows an advanced web services discovery framework integrating a WSIL explorer with a UDDI exploring engine.

With reference still to FIG. 1 (particularly, the numbers on lines connecting system components), in operation mode, a detailed flow of service description document chain exploration is described as follows:
(1A) Client requester 120 issues application programming interface (API) requests to invoke service description document exploration engine 102; and/or
(1B) Client requester 122 uses web browser to interact with search portal 110, which in turn invokes service description document exploration engine 102.
(2) Service description document exploration engine 102 invokes chain change detection module 106 to obtain changed service description documents.
(2A*) When configured as time-initiated mode, chain change detection is a background task that periodically checks the service description document chain, compares the information in the service description document chain against what is stored in services container 104, and collects a set of changed WSILs. When invoked, it returns the set of changed service description documents to the caller. Chain change detection can also accept a request on an on-demand basis to detect changes of a service description document chain or chains.
(3) Chain change detection module 106 returns the changed set, if any, to service description document exploration engine 102.
(4A) If there are changed service description documents, service description document exploration engine 102 re-explores changed service description documents.
(4B) Service description document exploration engine 102 updates services container 106 with new information about service and WSILs.
(5A) Service description document exploration engine 102 returns results to client 120, and/or
(5B) Service description document exploration engine 102 returns results to client 122.

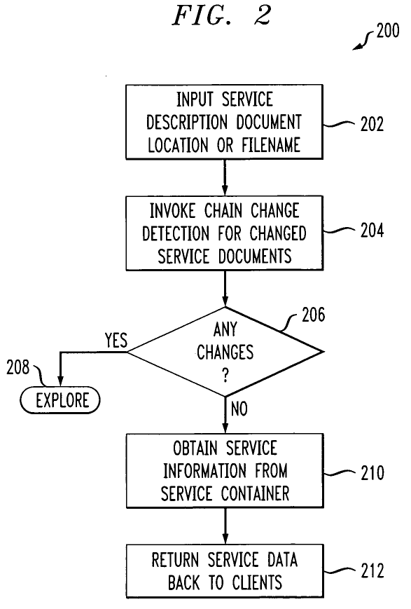

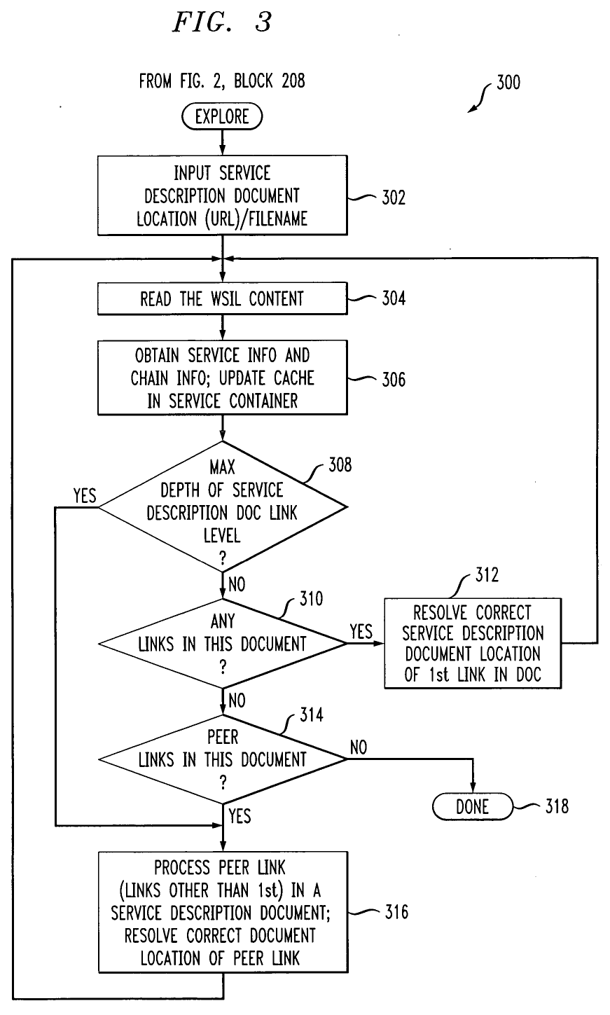

The implementation flow corresponding to system 100 shown in FIG. 1 is illustrated in FIG. 2. More particularly, FIG. 2 is a diagram illustrating a methodology for use in accordance with a service description document exploration engine, according to an embodiment of the present invention.

As shown, methodology 200 begins, at step 202, with the input of a service description document location or filename. This is received from client 120 or 122. In step 204, service description document exploration engine 102 invokes the chain change detection process (106). If any changes (block 206), the engine explores such changes in step 208. The exploration process is described below in the context of FIG. 3. If no changes (block 206), service information is obtained from service container 104. In step 212, service data is returned to the client.

Referring now to FIG. 3, a diagram illustrates a methodology for use in a service description document exploration engine for performing exploration of service description document chains and updating of service containers, according to an embodiment of the present invention. Methodology 300 may be considered a detailed description of step 208 of FIG. 2.

In step 302, a service description document location (e.g., uniform resource locator) or filename is input. In step 304, the WSIL content is read. In step 306, service information and chain information is obtained, and the cache (114) in service container 104 is updated.

In step 308, it is determined whether the maximun depth (which may be a configurable parameter) of the service description document link level has been reached. If not, it is determined in step 310 whether there are any links in the document. If yes, the correct service description document location in the first link in the document is resolved in step 312. If no links in the document, it is determined in step 314 whether there are any peer links, which are referred to as Web links or URIs in the same WSIL document. If yes, in step 316, the peer link is processed, and the correct document location of the peer link is resolved. Step 316 is also performed when the maximum link traversal depth is reached in step 308. After step 312 and/or step 316 is performed, the methodology returns to step 304. The methodology ends at block 318.

The detailed description now provides further detail of functional components of FIG. 1.

I. Services Container

As shown in FIG. 1, the service container component comprises the following two parts:
(1) Cached information 114 about services in each service description document chain and service description document chains themselves.
(2) Utilities 112 for accepting requests from external components, such as chain change detection module 106 and service description document exploration engine 102, to maintain the cached content, i.e., add, remove, and update, etc.

For each service description document chain, the following information is maintained in the services container:

Category name—The name that describes the category that all services within this service description document chain belong to in human-friendly terms, i.e., travel, finance, car, food, clothing, etc.

For each service description document linked in the chain, the following metadata may be stored in the service container: (i) creation time; (ii) document size; (iii) URL or WSIL location; and (iv) other signatures of a service description document, etc.

For each service found in the service description document chain, the following information may be cached in the services container: (i) service description document name/URL; (ii) service name; (iii) abstract; and (iv) WSDL location.

Descriptions for the categories may be maintained in the services container that serve as an index. The index may be based on the service abstract and service name and include additional metadata and keywords to facilitate a search.

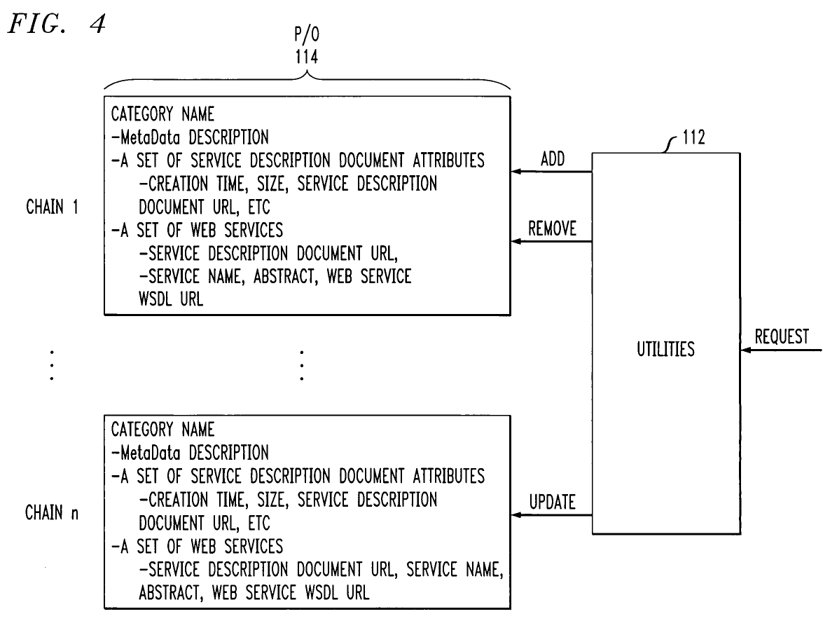

FIG. 4 is a diagram illustrating a service container architecture, according to an embodiment of the present invention. As shown, requests are received by utilities 112 which serve to add, remove and/or update the chain information stored in cache 114.

II. Chain Change Detection

Chain change detection (module 106) enables configuration of different granularity for different conditions. For example, a condition may be to stop checking for changes and immediately return at the first change, or search entire service description document chain after detecting a change. Another condition may be associated with activating chain change detection. In time-initiated checking, there may be a configurable interval of time that the chain change detection process will be turned on or off. This can be configured as the default behavior as well. In accordance with an on-demand basis, chain change detection may also accept a request from the service description document exploration engine to detect changes of a specific service description document chain or chains at runtime before exploring the chain or chains.

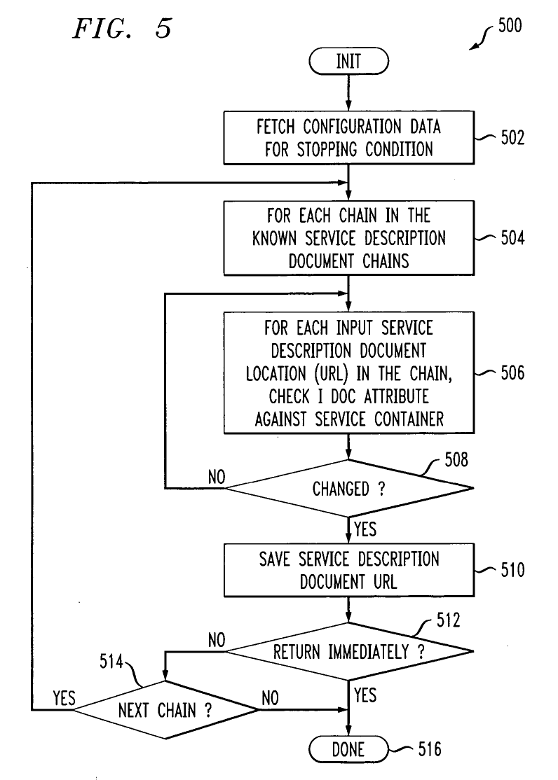

FIG. 5 is a diagram illustrating details of a chain change detection process, according to an embodiment of the present invention.

In an intialization stage, methodology 500 fetches configuration data for a stopping condition (step 502). Then, methodology 500 is applied to each chain in the known service description document chain (blcok 504).

In step 506, for each input service description document location (URL) in the chain, a document attribute is checked against information in the service container. If not changed (step 508), methodology 500 returns to step 506. If changed (step 508), the service description document URL is saved in step 510. If the results are to be returned immediately (step 512), then this is done and the process for that chain is completed (block 516). However, results for all the chains may be aggregated (step 514) and returned together.

III. Exploration of Service Description Document Chains

An example of a service description document chain 600 is shown in FIG. 6. Service description document exploration engine 102 provides a mechanism to search services in the WSIL-chain documents using the root WSIL, e.g., inspection.wsil 602 (Listing 1 below), which contain peer links to multiple WSILs, e.g., shipping.wsil 608 (Listing 4 below) and moreservices.wsil 604 (Listing 2 below), which links to yet another WSIL, e.g., anotherservices.wsil 606 (Listing 3 below).

Listing 1. Inspection.wsil:

```
<?xml version=“1.0” ?>
  <inspection xmlns=“http://schemas.xmlsoap.org/ws/2001/10/inspection/”
xmlns:wsilwsdl=“http://schemas.xmlsoap.org/ws/2001/
10/inspection/wsdl/”
xmlns:unknown=“http://tempuri.org/unknown/”>
  <service>
  <abstract xml:lang=“en-US”>A service with two descriptions that
contain relative URLs</abstract>
  <name xml:lang=“en-US”>StockQuoteService</name>
  <description referencedNamespace=“http://schemas.xmlsoap.org/wsdl/”
location=“stockquote.wsdl” />
  <description referencedNamespace=“http://tempuri.org/unknown/”
location=“service-description.unknown”>
  <abstract>This is an example of an unknown extension
  element</abstract>
  <unknown:service-description type=“unknown” />
  </description>
  </service>
  <link referencedNamespace=“http://schemas.xmlsoap.org/ws/
2001/10/inspection/” location=“moreservices.wsil”>
  <abstract>Link to another Service description document</abstract>
  </link>
  <link referencedNamespace=“http://schemas.xmlsoap.org/ws/
2001/10/inspection/” location=“shipping.wsil”>
  <abstract>Link to test Service description document</abstract>
  </link>
  </inspection>
```

Listing 2. Moreservices.wsil:

```
  <?xml version=“1.0” ?>
  <inspection xmlns=“http://schemas.xmlsoap.org/ws/2001/10/inspection/”
xmlns:wsilwsdl=“http://schemas.xmlsoap.org/ws/2001/10/
inspection/wsdl/”>
  <service>
  <abstract xml:lang=“en-US”>Another WSDL service
  description</abstract>
  <name xml:lang=“en-US”>AddressBookService</name>
  <description referencedNamespace=“http://schemas.xmlsoap.org/wsdl/”
location=“addressbook.wsdl” />
  </service>
  <link referencedNamespace=“http://schemas.xmlsoap.org/ws/
2001/10/inspection/” location=“anotherservices.wsil”>
  <abstract>Link to one more Service description document</abstract>
  </link>
  </inspection>
```

Listing 3. Anotherservices.wsil:

```
  <?xml version=“1.0” ?>
<inspection xmlns=“http://schemas.xmlsoap.org/ws/2001/10/inspection/”
xmlns:wsilwsdl=“http://schemas.xmlsoap.org/ws/2001/
10/inspection/wsdl/”>
<service>
  <abstract xml:lang=“en-US”>Another WSDL service
  description</abstract>
  <name xml:lang=“en-US”>HelloService</name>
  <description referencedNamespace=“http://schemas.xmlsoap.org/wsdl/”
location=“hello.wsdl” />
  </service>
  </inspection>
```

Listing 4. Shipping.wsil:

```
  <?xml version=“1.0” ?>
  <inspection xmlns=“http://schemas.xmlsoap.org/ws/2001/10/inspection/”
xmlns:wsilwsdl=“http://schemas.xmlsoap.org/ws/2001/
10/inspection/wsdl/”>
<service>
  <abstract xml:lang=“en-US”>Another WSDL service
  description</abstract>
  <name xml:lang=“en-US”>ShippingService</name>
  <description referencedNamespace=“http://schemas.xmlsoap.org/
wsdl/” location=“shipping.wsdl” />
  </service>
  </inspection>
```

(a) WSIL Exploration for Design Collaboration Scenario

As mentioned above, design collaboration solutions realized by the invention enable companies to bring a product development team up in a matter of hours and could be used to establish an effective team-working environment within the enterprise as well as across the enterprise.

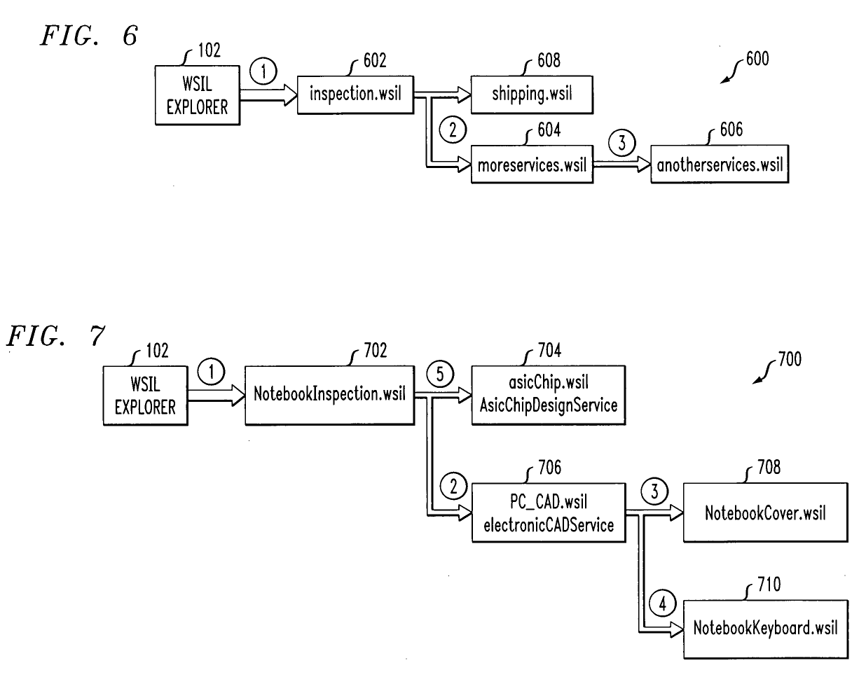

An example of a service description document chain 700 for design collaboration is shown in FIG. 7. In the illustrative design collaboration scenario, five service description documents form a service description document chain enabling rapid integration. Service description document exploration engine 102 provides a mechanism to search services in the WSIL-chain documents using the root WSIL, e.g., NotebookInspection.wsil 702, which contain peer links to multiple WSILs, i.e., asicChip.wsil 704 and PC_CAD.wsil 706, which links to two more WSILs, i.e., NotebookCover.wsil 708 and NotebookKeyboard.wsil 710.

(b) WSIL Explorer APIs

Java APIs are provided for the client to obtain a list of web services from multiple service description document chains. Sample APIs are listed below in Listing 5. They may take different input, i.e., WSIL URL, WSILDocument, and wsilFileName:

Listing 5:

public Vector findServiceByURL_Vector(String inputWSILUrl);
public String findServiceByURL(String inputWSILUrl);
public Vector findServiceByWSIL_Vector(String inputWSILUrl,
WSILDocument wsildoc);
public String findServiceByWSIL(String inputWSILUrl,
WSILDocument wsildoc);
public String findServiceByFileName(String wsilFileName);
public Vector findServiceByFileName_Vector(String wsilFileName).

In Listing 6 below, the initial service description document URL is “http://tempuri.wsil.com/wsil/inspection.wsil”, and it shows an example output after traversing a service description document chain of four service description documents and finding a total of four services, displayed in three separate fields, i.e., abstract, name and location.

Listing 6:

wsilurl=http://tempuri.wsil.com/wsil/inspection.wsil
input wsilurl=http://tempuri.wsil.com/wsil/moreservices.wsil
input wsilurl=http://tempuri.wsil.com/wsil/anotherservices.wsil
input wsilurl=http://tempuri.wsil.com/wsil/shipping.wsil
getServiceDetails::size of servicesDetails=4
[0]:
abstract:A service with two descriptions that contain relative URLs
name:StockQuoteService
location=stockquote.wsdl
[1]:
abstract:Another WSDL service description
name:AddressBookService
Location=addressbook.wsdl
[2]:
abstract:Another WSDL service description
name:HelloService
location=hello.wsdl
[3]:
abstract:Another WSDL service description
name:ShippingService
location=shipping.wsdl

In Listing 7 below, an example is shown of an output after traversing the same service description document chain of four service description documents with a total of four services found, displayed in service description document format for the same three separate fields, i.e., abstract, name and location, for each service.

Listing 7:

```
<?xml version=“1.0”?>
<inspection xmlns=“http://schemas.xmlsoap.org/ws/2001/
10/inspection/”
xmlns:wsilwsdl=“http://schemas.xmlsoap.org/ws/
2001/10/inspection/wsdl/”
      xmlns:unknown=“http://tempuri.org/unknown/”>
  <service>
    <abstract>A service with two descriptions that contain relative
URLs</abstract>
    <name xml:lang= “en-US”>StockQuoteService</name>
    <description referencedNamespace=“http://
schemas.xmlsoap.org/wsdl/” location=“stockquote.wsdl”/>
  </service>
  <service>
    <abstract>Another WSDL service description</abstract>
    <name xml:lang=“en-US”>AddressBookService</name>
    <description referencedNamespace=“http://
schemas.xmlsoap.org/wsdl/” location=“addressbook.wsdl”/>
  </service>
  <service>
    <abstract>Another WSDL service description</abstract>
    <name xml:lang= “en-US”>HelloService</name>
    <description referencedNamespace=“http://
schemas.xmlsoap.org/wsdl/” location= “hello.wsdl”/>
  </service>
  <service>
    <abstract>Another WSDL service description</abstract>
    <name xml:lang=“en-US”>ShippingService</name>
    <description referencedNamespace=“http://
schemas.xmlsoap.org/wsdl/” location=“shipping.wsdl”/>
  </service>
</inspection>
```

(c) Example Embodiment: WSIL Exploration Portal

In this example embodiment, a sample portal (e.g., portal 110) is provided to search services in a given service description document chain or WSIL chain using the service description document exploration engine.

In this example, a service description document chain with the same set of four service description documents mentioned above in section (a) is used in the portal embodiment.

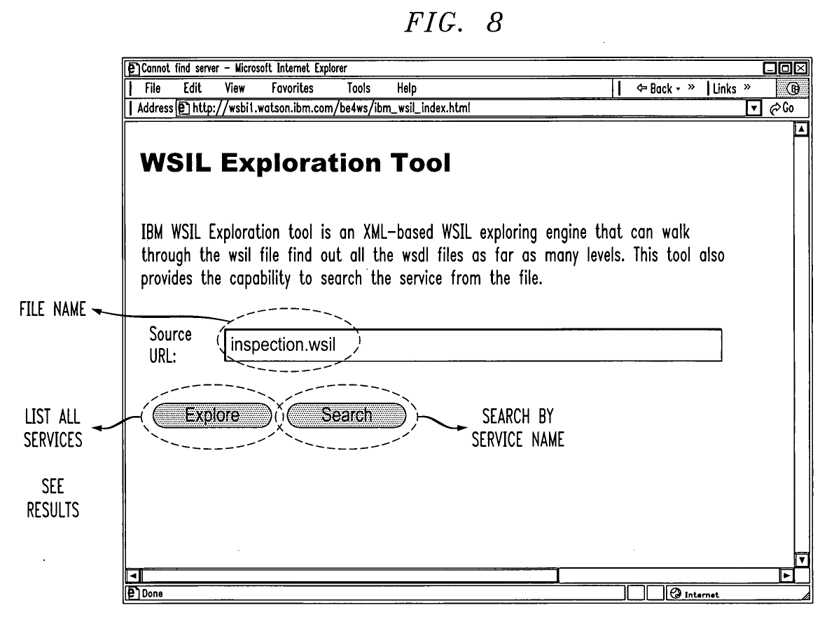

In FIG. 8, the root service description document of the service description document chain, i.e., inspection.wsil, is specified, and the ‘Explore’ button is selected. The output is shown in FIG. 9 with a total of four services found after traversing the chain.

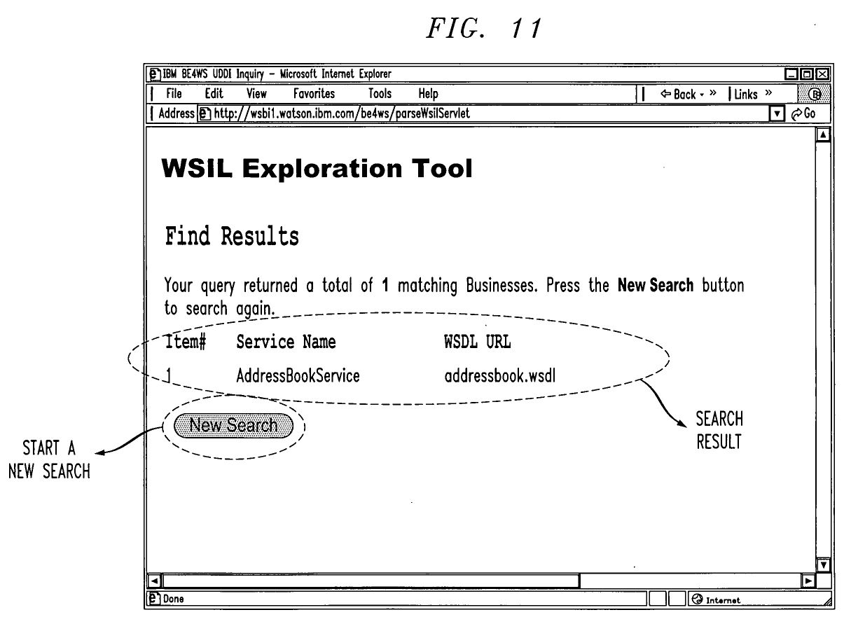

FIG. 10 shows a screen when the ‘Find’ button of FIG. 9 is selected to search for service names, and in this case, the search criteria is ‘ServiceName’ selected via the dropdown box.

In the text area, the service name starting with ‘Address’ is entered.

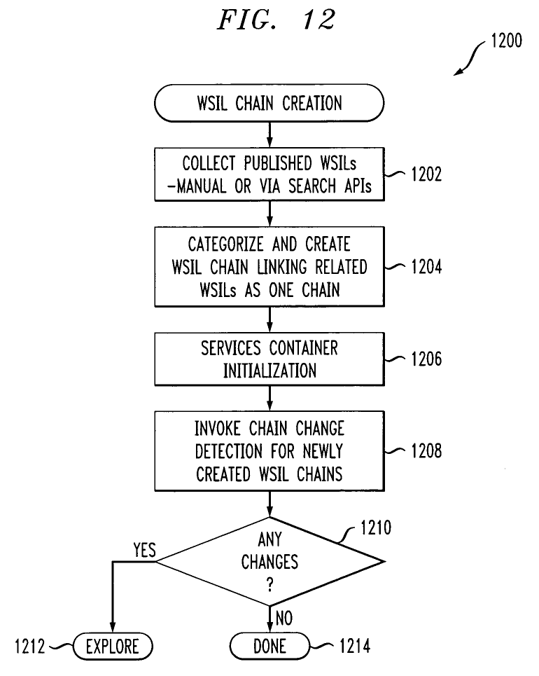

FIG. 11 shows the result when a service named ‘AddressBookService’ is found and displayed in the output.

(d) Search Result Aggregation from Multiple Service Description Document Chains

As mentioned above, the WSIL exploration mechanism described herein is capable of aggregate results from multiple service description document chains as illustrated by the ‘Explore’ function of the WSIL exploration portal. That is, the service description document exploration engine can iteratively explore multiple service description document chains and then aggregate the results together for display all at once.

In Listing 8 below, an XML script is shown that describes two queries for two different service description document chains with one root service description document being inspection1.wsil and the other being inspection2.wsil.

Listing 8:

```
<?xml version=“1.0”?>
<Search>
<Query>
  <wsilUrl>inspection1.wsil</wsilUrl>
  <wsilCriteria>adressbook</wsilCriteria>
</Query>
<Query>
  <wsilUrl>inspection2.wsil</wsilUrl>
  <wsilCriteria>stock</wsilCriteria>
</Query>
<AggOperator>OR</AggOperator>
</Search>
```

(e) Service Description Document Chain Creation
(i) Manual Creation: manually search Internet or Intranet to get a list of WSIL files (e.g., categorize them and link to them in the first WSIL file).
(ii) Automatic Creation/Updating: Use existing web search engine APIs (e.g., Google Web Services Interfaces or regular common gateway interface (CGI) APIs) to find WSIL files published on the World Wide Web. Then, categorize them and automatically link to them in the first WSIL file.

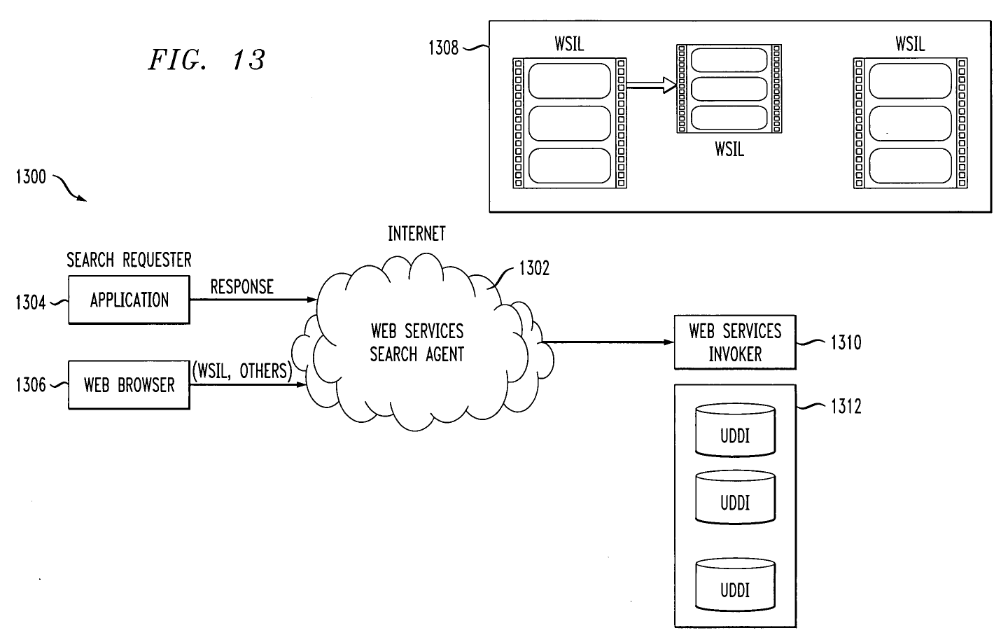

FIG. 12 is a diagram illustrating details of a service description document chain creation process, according to an embodiment of the present invention.

Methodology 1200 begins at step 1202 where published WSILs are collected (either manually or via search APIs). In step 1204, the methodology categorizes and creates a WSIL chain linking related WSILs as one chain. In step 1206, a services container is initialized. In step 1208, the methodology invokes chain change detection for newly created WSIL chains. If there are any changes (step 1210), these changes are explored in step 1212 as explained above. If no changes (step 1210), the creation methodology ends in block 1214.

(f) WSIL Explorer Based Web Services Integration Framework

An advanced web services discovery framework (WSDF) according to the invention deals with the above-mentioned problems and limitations in a UDDI search head-on. The framework provides an easy to use mechanism, XML-based script, that shields the application developers from complex Java programming using either WSIL4J (Web Services Description Language for Java Toolkit) or UDDI4J (UDDI for Java, a class library that provides an API to interact with a UDDI (Universal Description, Discovery and Integration) registry), as well as provides capabilities for union and intersection of multiple search queries from one or more UDDI registries.

The framework is designed to meet the following objectives:
(i) Using uniform interfaces such as a Java interface and web services interfaces to expose an advanced web services discovery engine.
(ii) Simplifying the application developer's work via the use of the XML-based search script.
(iii) Hiding the complexity of UDDI search client and WSIL search client.
(iv) Performing result aggregation from one or multiple data sources (e.g., UDDI registries and service description documents).
(v) Acting as an advanced search portal on an application server.

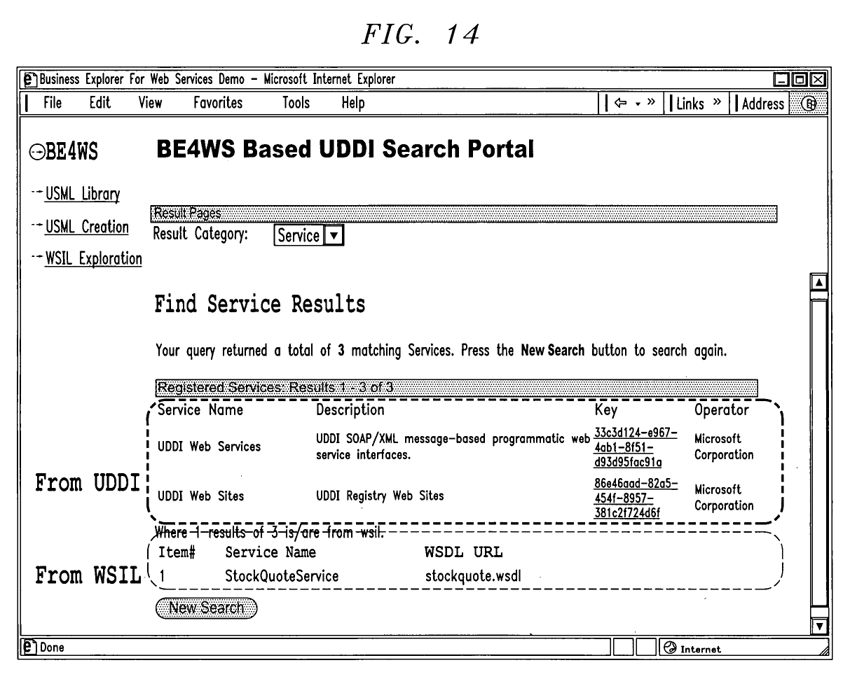

A script based search agent can play an important role in simplifying the application developer's job in developing web browser-based clients or e-business applications for web services discovery. FIG. 13 illustrates an architecture for an advanced web services discovery framework (WSDF) with a search agent. The advanced web services search agent can be accessible by either a regular application client or by a web browser.

As shown in architecture 1300 of FIG. 13, search agent 1302 is in communication with application 1304, web browser 1306, WSILs 1308, web services invoker 1310 and UDDI registries 1312.

The web services search agent implements a sophisticated result aggregation mechanism and communicates with multiple UDDI registries and WS-Inspection documents. When a service requester looks for a web service, the search agent can respond with one or all of the three basic data types, businessEntity, businessService, and ServiceType (i.e., Technical Model, or t-Model) retrieved from UDDI registries. The example aggregation includes, but is not limited to, operations of intersection, union and script-based logic to operate on the responses from multiple sources. The final response to the search requester maybe a new XML format or an existing XML format such as WSIL, which can emerge as a player in representing the aggregated search results.

In the mean time, the web services search agent automatically invokes a set of web services to obtain the actual results or just to explore the web services capabilities. The search agent could be deployed on a separate machine from UDDI registries or service description documents or deployed on the same machine that the UDDI registries or service description documents reside.

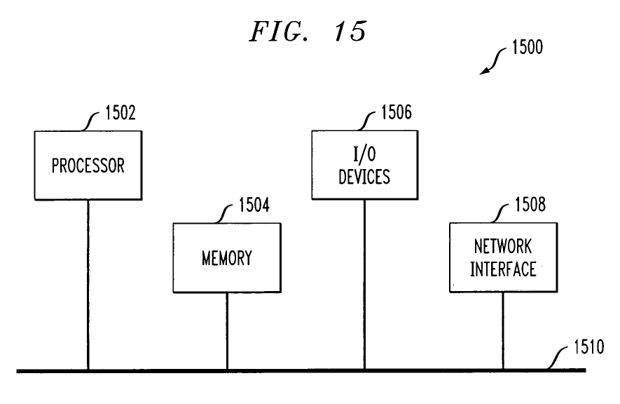

Listing 9 below shows an example search script that searches for one UDDI registry and one service description document chain. The aggregated search result is shown in FIG. 14. That is, the first two services come from the UDDI registry; and the last service comes from the service description document chain.

Listing 9:

```
<?xml version=“1.0”?>
<Search>
<Query>
<Source>Microsoft Public UDDIV2</Source>
<SourceURL>http://uddi.rte.microsoft.com/inquire</SourceURL>
<ServiceName>UDDI</ServiceName>
<BusinessName>Microsoft</BusinessName>
<FindBy>Service</FindBy>
</Query>
<Query>
  <wsilUrl>inspection.wsil</wsilUrl>
  <wsilCriteria>stock</wsilCriteria>
</Query>
<AggOperator>OR</AggOperator>
</Search>
```

Referring finally to FIG. 15, a block diagram illustrates an illustrative hardware implementation of a computing system in accordance with which one or more components/methodologies of the present invention (e.g., components/methodologies described in the context of FIGS. 1 through 14) may be implemented, according to an embodiment of the present invention. For instance, such a computing system in FIG. 15 may implement a services discovery system 102, a client 120, 122 (FIG. 1), a search agent 1302 (FIG. 13), etc.

It is to be understood that such individual components/methodologies may be implemented on one such computer system, or on more than one such computer system. In the case of an implementation in a distributed computing system, the individual computer systems and/or devices may be connected via a suitable network, e.g., the Internet or World Wide Web. However, the system may be realized via private or local networks. The invention is not limited to any particular network.

As shown, computer system 1500 may be implemented in accordance with a processor 1502, a memory 1504, I/O devices 1506, and a network interface 1508, coupled via a computer bus 1510 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., speaker, display, etc.) for presenting results associated with the processing unit. Such output devices may also be used to present graphical user interfaces such as those shown in FIGS. 8-11 and 14.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Advantageously, the invention provides the above and other features but does not need to attach any property to the document itself nor need to use an attached property to control the behavior, manipulate or reconstruct the document contents, or change system configurations. Documents being searched need not be self-contained, and may be unaltered with any properties attached. Instead, the invention builds a centralized control structure around the documents it searches. Also, the invention provides a search engine to: (i) track and detect the changes of the documents by periodically updating and looking up the centralized control structure; and (ii) deep search multi-layered documents. The invention also provides caching of the document and control structure to speed up the lookup as well as provides a mechanism, i.e., control parameters, to manipulate and adjust the granularity of the caching. The invention may also pre-categorize the documents of interest prior to search.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method of discovering services available in accordance with an information network, comprising the steps of:
obtaining a request from a client to perform a search for one or more services;
searching a set of one or more service description documents, based on the client request, wherein the searching step further comprises detecting that one or more changes have occurred in the set of one or more service description documents; and
making a result of the search available to the client.

2. The method of claim 1, wherein the detecting step further comprises comparing at least a portion of a current instance of the set of one or more service description documents to at least a portion of a previous instance of the set of one or more service description documents.

3. The method of claim 2, wherein at least a portion of the previous instance of the set of one or more service description documents is stored in a cache.

4. The method of claim 2, wherein at least a portion of the current instance of the set of one or more service description documents is used to update a cache.

5. The method of claim 1, further comprising the step of aggregating sub-results obtained during the searching step into an aggregated result, and then making the aggregated result available to the client.

6. The method of claim 5, wherein the sub-results comprise services obtained during the searching step.

7. The method of claim 1, further comprising the step of obtaining information used to control performance of the searching step.

8. The method of claim 1, wherein the searching step is performed in association with multiple data sources.

9. The method of claim 1, wherein the searching step is configurable to be performed at different levels of granularity.

10. The method of claim 1, wherein the one or more services comprise one or more web services.

11. A method of querying one or more service description documents, comprising the steps of:
receiving at least one query;
identifying a target data source for the at least one query; and
exploring the target data source with at least one service description document.

12. The method of claim 11, wherein the at least one query comprises at least one location of a service description document.

13. The method of claim 11, wherein the at least one query can be expressed in terms of one or more of: (i) an extensible markup language; (ii) a HyperText Transport Protocol request string; (iii) one or more input parameters in an application programming interface; and (iv) a form comprising at least one of a location of a service description document and a search criterion.

14. The method of claim 11, wherein the target data source comprises at least one of: (i) at least one service description document with zero or more traverse links to other service description documents; and (ii) a service container.

15. Apparatus for discovering services available in accordance with an information network, comprising:
a memory; and
at least one processor coupled to the memory and operative to: (i) obtain a request from a client to perform a search for one or more services; (ii) search a set of one or more service description documents, based on the client request, wherein the searching step further comprises detecting that one or more changes have occurred in the set of one or more service description documents; and (iii) make a result of the search available to the client.

16. The apparatus of claim 16, wherein the detecting operation further comprises comparing at least a portion of a current instance of the set of one or more service description documents to at least a portion of a previous instance of the set of one or more service description documents.

17. The apparatus of claim 16, wherein at least a portion of the previous instance of the set of one or more service description documents is stored in a cache associated with the memory.

18. The apparatus of claim 16, wherein at least a portion of the current instance of the set of one or more service description documents is used to update a cache associated with the memory.

19. The apparatus of claim 15, wherein the at least one processor is further operative to aggregate sub-results obtained during the searching operation into an aggregated result, and then make the aggregated result available to the client.

20. The apparatus of claim 19, wherein the sub-results comprise services obtained during the searching operation.

21. The apparatus of claim 15, wherein the at least one processor is further operative to obtain information used to control performance of the searching operation.

22. The apparatus of claim 15, wherein the searching operation is performed in association with multiple data sources.

23. The apparatus of claim 15, wherein the searching operation is configurable to be performed at different levels of granularity.

24. The apparatus of claim 15, wherein the one or more services comprise one or more web services.

25. An article of manufacture for discovering services available in accordance with an information network, comprising a machine readable medium containing one or more programs which when executed implement the steps of:
obtaining a request from a client to perform a search for one or more services;
searching a set of one or more service description documents, based on the client request, wherein the searching step further comprises detecting that one or more changes have occurred in the set of one or more service description documents; and
making a result of the search available to the client.

26. A system for automatic exploration of one or more multi-level service description document chains, comprising:
a service container containing at least one cached web service;
a chain change detection module to detect changes in service description document chains; and
a service description document exploration engine coupled to the service container and the chain change detection module for performing automatic exploration of multi-level service description document chains.

27. The system of claim 26, further comprising one or more control parameters to control operation of the service description document exploration engine.

28. The system of claim 26, wherein the service container comprises at least one of: (i) cached information about one or more web services referenced in at least one service description document chain; (ii) service description document chain information including at least the location of at least one service description document; and (iii) utilities to update and maintain the cached content.

29. The system of claim 28, wherein the cached information for each web service found in the service description document chain further comprises at least one of: (i) a service description document name/URL; (ii) a service name; (iii) an abstract; (iv) a WSDL location; and (iv) one or more category descriptions.

30. The system of claim 28, wherein the cached information for each service description document chain comprises at least one of: (i) a creation time; (ii) a document size; (iii) a URL or service description document location; and (iv) other signatures of a service description document.

31. The system of claim 26, wherein the chain change detection module performs one of a time-initiated checking operation and an on-demand checking operation.

32. The system of claim 27, wherein the one or more control parameters comprise one or more parameters for controlling: (i) a maximum depth to traverse; (ii) turning caching on or off; (iii) target data source display data; (iv) a stopping condition for performing chain change detection; and (v) a determination of which data source is to be a target data source.

33. The system of claim 26, wherein the system serves as a web services search agent.

34. A method of creating a service description document chain, comprising the steps of:
collecting a set of published service description documents by using one of a manual search and an automated search engine application programming interface;
linking related service description documents to form a service description document chain;
invoking a chain change detection process to collect changes to the service description documents in the chain and then invoking a service description document exploration process to explore the chain; and
storing results of the processes in a cache.

35. A method for providing a service, in accordance with a service provider, to allow discovery of services available in accordance with an information network, the method comprising the step of:
deploying a service discovery system operative to: (i) obtain a request from a client to perform a search for one or more services; (ii) search a set of one or more service description documents, based on the client request, wherein the searching step further comprises detecting that one or more changes have occurred in the set of one or more service description documents; and (iii) make a result of the search available to the client.
